(19) United States
(12) Patent Application Publication
(10) Pub. No.: US 2005/0251652 A1
(43) Pub. Date: Nov. 10, 2005

(54) Methods and apparatus for processing an extensible firmware interface byte code instruction in a loop

(76) Inventor: Eswaramoorthi Nallusamy, Tamil Nadu (IN)

Correspondence Address: HANLEY, FLIGHT & ZIMMERMAN, LLC, 20 N. WACKER DRIVE, SUITE 4220, CHICAGO, IL, 60606, US

(21) Appl. No.: 10/832,505

(22) Filed: Apr. 27, 2004

(51) Int. Cl. G06F 9/30

(52) U.S. Cl. 712/209; 712/241

(57) ABSTRACT

Methods and apparatus to process a virtual machine instruction in a loop are described herein. In an example method, at least one of a loop-start instruction and a loop-end instruction associated with a loop having the virtual machine instruction is monitored. In response to detecting the loop-start instruction, the virtual machine instruction is validated. Further, the virtual machine instruction is converted into one or more native instructions in response to a failure to detect the loop-end instruction. Other embodiments may be described and claimed.

### TECHNICAL FIELD

The present disclosure relates generally to compilers and virtual machines, and more particularly, to methods and apparatus for processing an extensible firmware interface byte code instruction in a loop.

### BACKGROUND

In an effort to reduce code size and cost of maintenance, extensible firmware (EFI) byte code (EBC) images are developed to be platform and processor-independent so that an EBC virtual machine (EBCVM) may load and execute the EBC images on multiple platforms. In other words, the EBC images are developed to be compatible with different processing architectures. For example, an EBC image may be compatible with an IA-32 Intel® Architecture processor and an IA-64 Intel® Architecture processor. In general, the EBC image contains EBC executables, which include platform-independent predefined instructions generated by an EBC compiler. The EBCVM provides handler routines to decode and execute the EBC instructions of the EBC image.

Typically in an EFI-based processing environment, the EBCVM may use EFI services such as LoadImage( ) to load the EBC image into volatile memory and StartImage( ) to initiate execution of the EBC image by issuing a call to an entry point of the EBC image. The EBC image includes instructions understandable by only the EBCVM. Accordingly, the LoadImage® service uses the CreateThunk( ) service provided by the EBCVM to generate a thunk (e.g., code configured to serve as an interface between the EBCVM and the underlying processor) corresponding to the entry point of the EBC image. Subsequently, the EBCVM takes control of the execution of the EBC image when the StartImage( ) service issues a call to the entry point of the EBC image. In particular, the EBCVM invokes handler routines to validate operating parameters such as opcodes and operands associated with the EBC instructions.

In existing systems, however, the EBCVM may inefficiently perform validations of the opcodes and operands associated with EBC instructions of the EBC image. In particular, each time that an EBC instruction is executed in a loop, for example, the EBCVM validates the opcode and operands associated with the EBC instruction even though the opcode and operands do not change. Such redundant validations of opcodes and operands significantly increase the number of clock cycles needed to execute the loop.

### BRIEF DESCRIPTION OF THE DRAWINGS

FIG. 1 is a block diagram representation of an example architectural hierarchy of an EFI-based processing system according to an embodiment of the methods and apparatus disclosed herein.

FIG. 2 is a block diagram representation of an example EBC instruction processing system.

FIG. 3 depicts high level language example source code.

FIG. 4 depicts example EBC assembly language corresponding to the example source code of FIG. 3.

FIG. 5 is a representation of an example EBC instruction that may be processed by the example EBC instruction processing system of FIG. 2.

FIG. 6 is a flow diagram representation of a known manner of processing an EBC image.

FIG. 7 is a flow diagram representation of a known manner of processing an EBC instruction.

FIG. 8 depicts a portion of an example opcode table associated with the example EBC instruction processing system of FIG. 2.

FIG. 9 depicts a portion of an example handler routine associated with the example EBC instruction processing system of FIG. 2.

FIG. 10 is a flow diagram representation of one manner in which the example EBC instruction processing system of FIG. 2 may be configured to process an EBC instruction in a loop in accordance with an embodiment of the teachings of the invention as disclosed herein.

FIG. 11 is a flow diagram representation of one manner in which the example EBC instruction processing system of FIG. 2 may be configured to implement an example loop-start handler process.

FIG. 12 is a representation of example native instructions corresponding to the EBC assembly language of FIG. 4.

FIG. 13 is a block diagram representation of an example processor system that may be used to implement the example EBC instruction processing system of FIG. 2.

### DETAILED DESCRIPTION

In general, methods and apparatus to process virtual machine instructions associated with a virtual machine image are described herein. For example, the methods and apparatus disclosed herein may be used to process an EBC instruction in a loop of an EBC image by monitoring for a loop-start instruction and a loop-end instruction associated with the loop, validating the EBC instruction in response to detecting the loop-start instruction, and converting the EBC instruction into one or more native instructions until the loop-end instruction is encountered. As a result, the EBC image may be processed more efficiently as described in detail below.

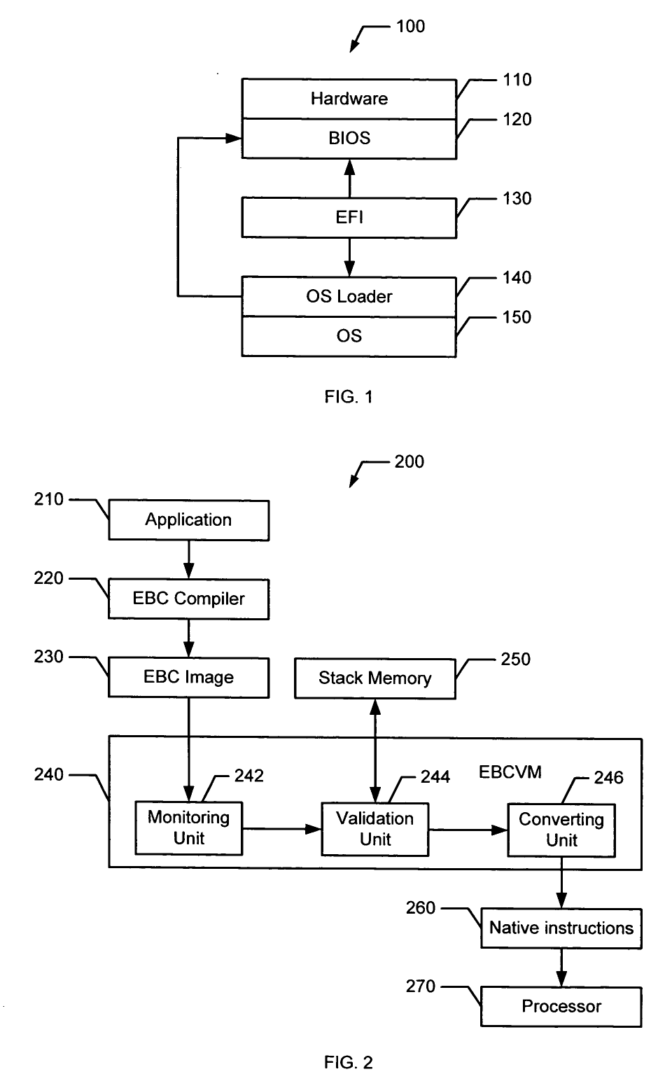

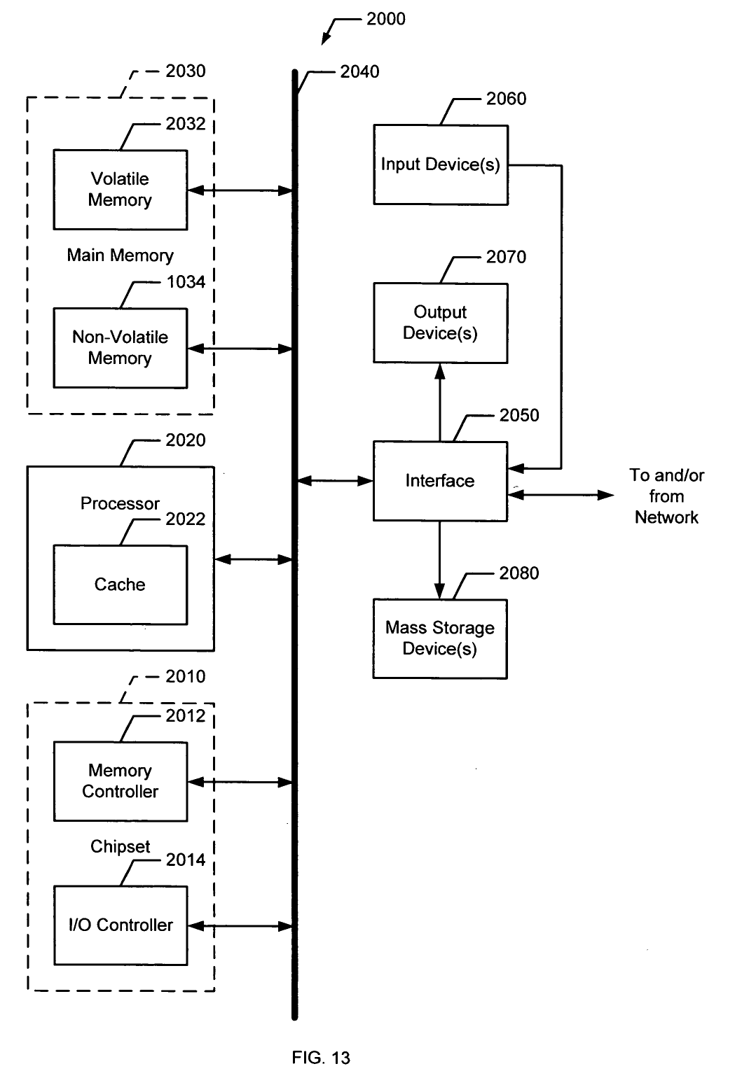

Referring to FIG. 1, an architectural hierarchy 100 of an EFI-based processor system (e.g., processor system 2000 of FIG. 13) includes hardware 110, a basic input/output system (BIOS) 120, an EFI 130, an operating system (OS) loader 140, and an OS 150. Persons of ordinary skill in the art will readily recognize that hardware 110 may include any physical aspect of the processor system such as a processor (e.g., the processor 2020 of FIG. 13) and a main memory (e.g., the main memory 2030 of FIG. 13). Hardware 110 also includes an interface circuit, input device(s), output devices, and/or the mass storage device. The hardware 110 may be implemented using any or all of the components shown in FIG. 13. The BIOS 120 may be implemented as software, firmware or machine readable instructions configured to boot (i.e., start up) the processor system in a conventional manner. To boot the OS 150 (e.g., Windows® and/or Linux) and to run pre-boot applications, the BIOS 120 manages data flow between the hardware 110 of the processor system 100 via the EFI 130. The EFI 130 is used to define an interface between operating systems and platform firmware to assist the processor system in managing data flow. For example, the EFI 130 may define an interface between the OS 150 and the BIOS 120 to manage data flow therebetween. The EFI 130 includes of data tables containing platform-related information. The EFI 130 also includes boot and runtime service calls that are available to the OS 150 and the OS loader 140. Accordingly, the EFI 130 provides a standard environment for booting the OS 150 and running pre-boot applications. For example, the EFI 130 may operate in accordance with the Extensible Firmware Interface Specification version 1.10 (or later) developed by Intel® Corporation. Additional information pertinent to the EFI 130 is available at http://developer.intel.com/technology/efi. Alternatively, the BIOS 120 may directly communicate with the OS 150 without the EFI 130 in a conventional manner.

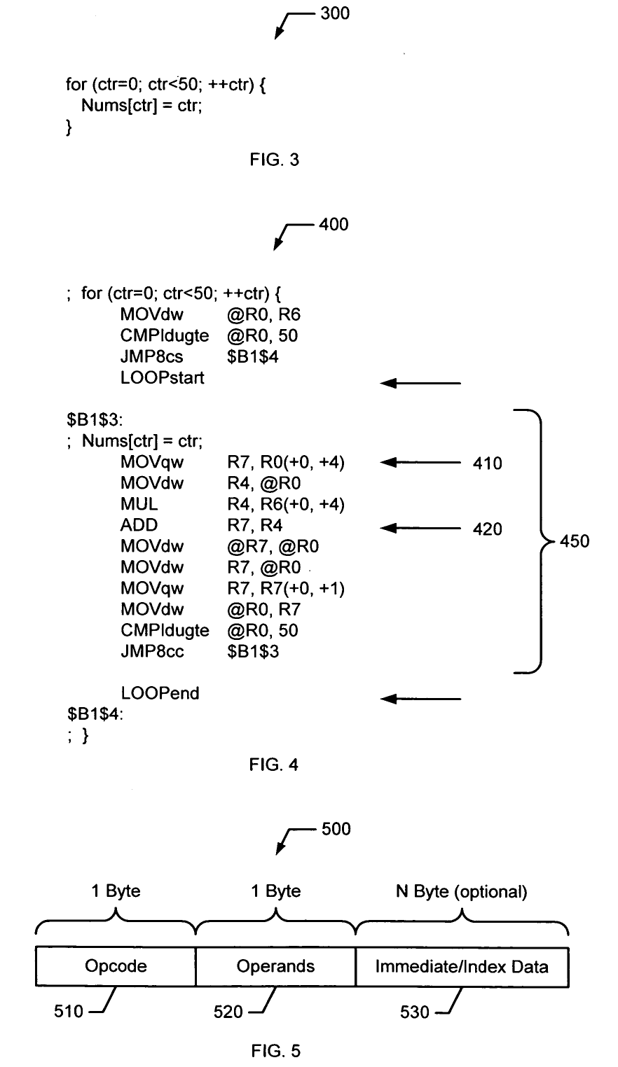

Based on the architectural hierarchy 100 of FIG. 1, a processing system may be configured to process an EBC image having a plurality of EBC instructions. In the example of FIG. 2, an EBC instruction processing system 200 includes an application 210, an EBC compiler 220, an EBC image 230, an EBCVM 240, a stack memory 250, native instructions 260, and a processor 270. As used herein the term “application” refers to one or more methods, programs, functions, routines, or subroutines for manipulating data. Turning to FIG. 3 as an example, the application 210 may be implemented by source code 300 written in C programming language. In particular, the source code 300 may include a “for” loop (i.e., “for (ctr=0; ctr<50; ++ctr)”) to execute one or more instructions repeatedly. The EBC compiler 220 may compile the source code 300 of the application 210 to generate the EBC image 230. While the source code 300 shown in FIG. 3 is written C programming language, the source code 300 may be written in other programming languages such as, for example, C++.

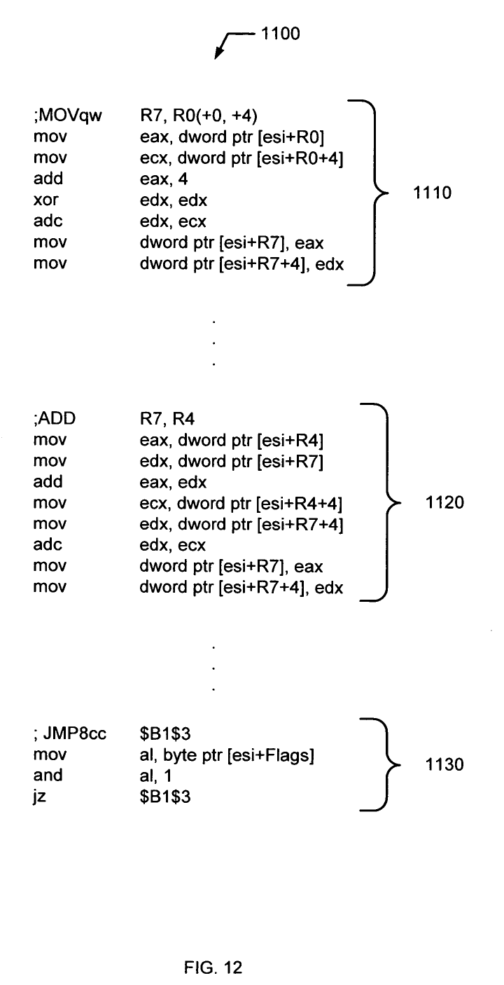

As illustrated in FIG. 4, for example, the EBC image 230 may be represented by EBC assembly code 400 corresponding to the source code 300. The EBC image 230 includes a plurality of EBC instructions executable by the EBCVM 240, which in turn are converted into native instructions 260 (e.g., native instructions 1100 of FIG. 12) executable by the underlying processor 270 as described in detail below.

Each of the plurality of EBC instructions in the EBC image 230 may include operating parameters indicating an operation to be performed, data with which the operation is to be performed, size of the data, etc. In the example of FIG. 5, each EBC instruction 500 includes a one byte opcode 510 and a one byte operand 520. The EBC instruction 500 may also include index or immediate data 530. The opcode byte 510 specifies the operation to be performed, an operand size, and indicates whether index or immediate data is present. The operand byte 520 specifies one or more registers of the EBCVM 240 associated with data with which the operation is to be performed as well as the type of operand (e.g., direct or indirect). The index or immediate data 530 includes the data with which the operation is to be performed and/or specifies the size of the data. Referring back to FIG. 4, for example, the EBC instruction 410 includes an opcode “MOVqw,” operands “R7, R0,” and index or immediate data “(+0, +4).” In another example, the EBC instruction 420 includes an opcode “ADD,” and operands “R7, R4,” and does not include any index or immediate data.

Typically, the EBCVM 240 may use EFI services such as LoadImage( ) to load the EBC image 230 and StartImage( ) to initiate processing of the EBC image 230. The EBCVM 240 provides its services to an EFI-based processing environment (e.g., the processor system 100 of FIG. 1). To execute the EBC image 230 using the EBCVM 240, the EFI 130 generates a thunk to identify an entry point for the EBC image 230 when the LoadImage( ) service loads the EBC image 230 to a volatile memory such as a random access memory (RAM). Accordingly, when the EFI 130 invokes the StartImage( ) service, the EBCVM 240 takes control of the image execution and executes EBC instructions associated with the EBC image 230. The EBCVM 240 generates a VM context for the EBC image 230, stores the VM context in the stack memory 250, and invokes respective handler function for each EBC instruction to execute the EBC instruction. For example, the VM context may include eight general purpose registers, one instruction pointer (IP) register, one flag register, and a stack. In existing systems, the handler functions may execute the EBC instructions based on the VM context.

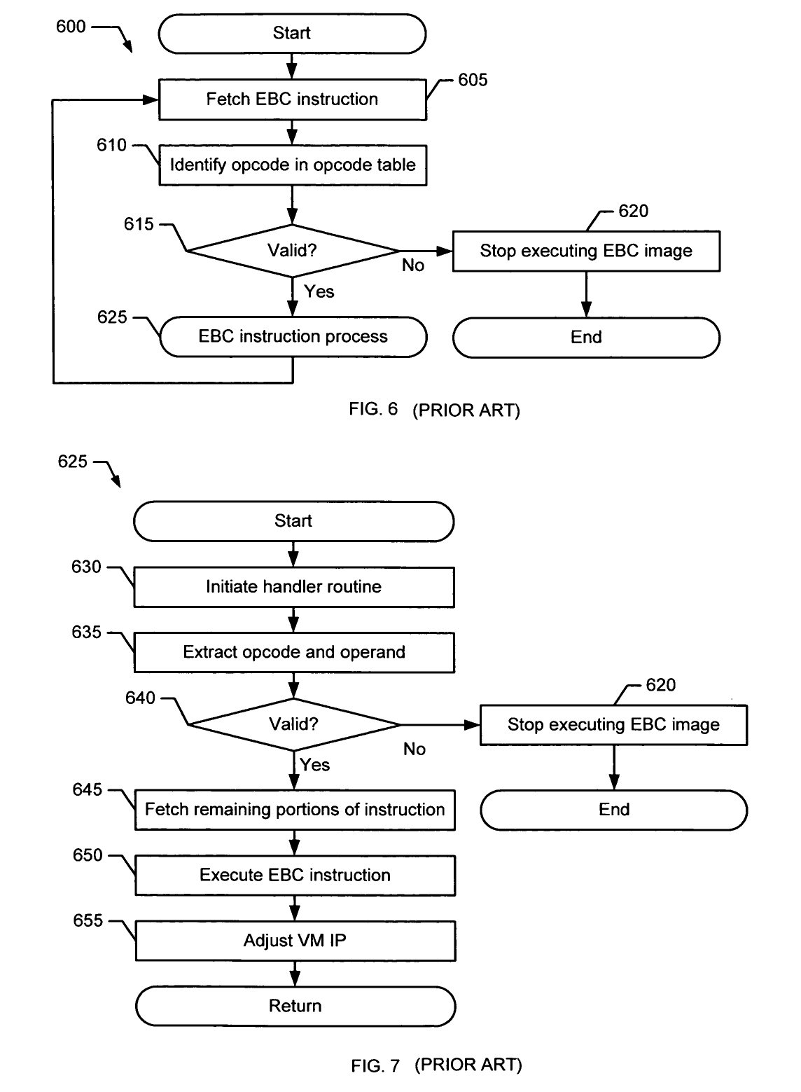

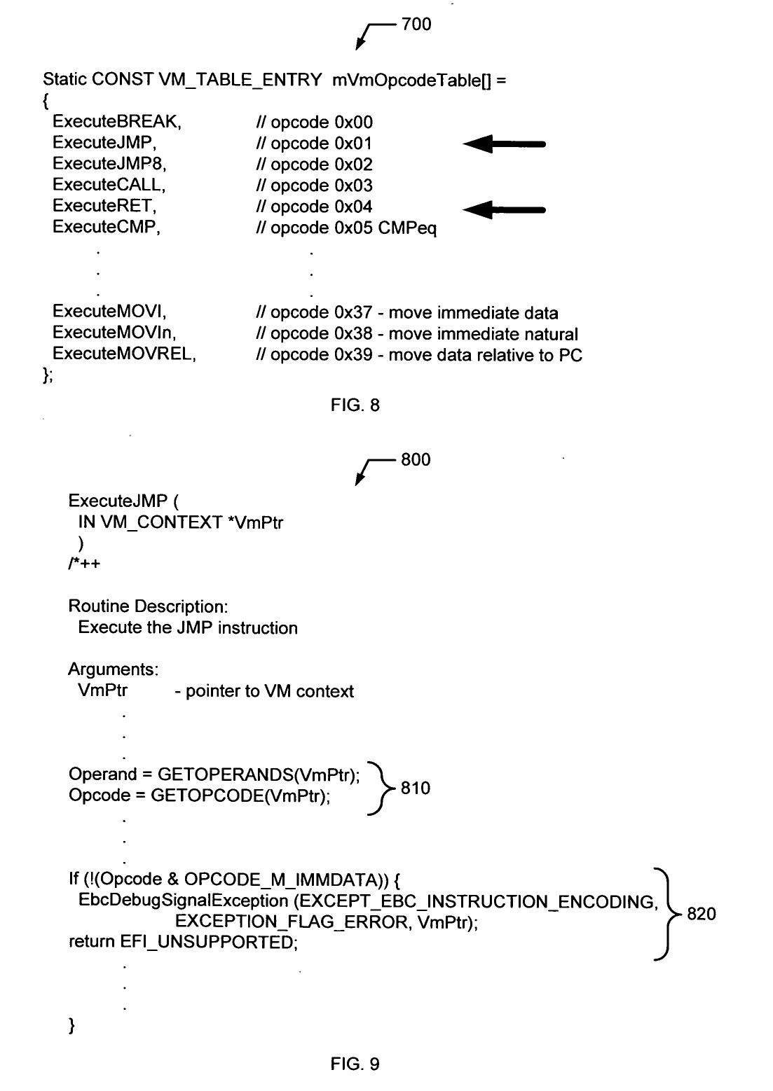

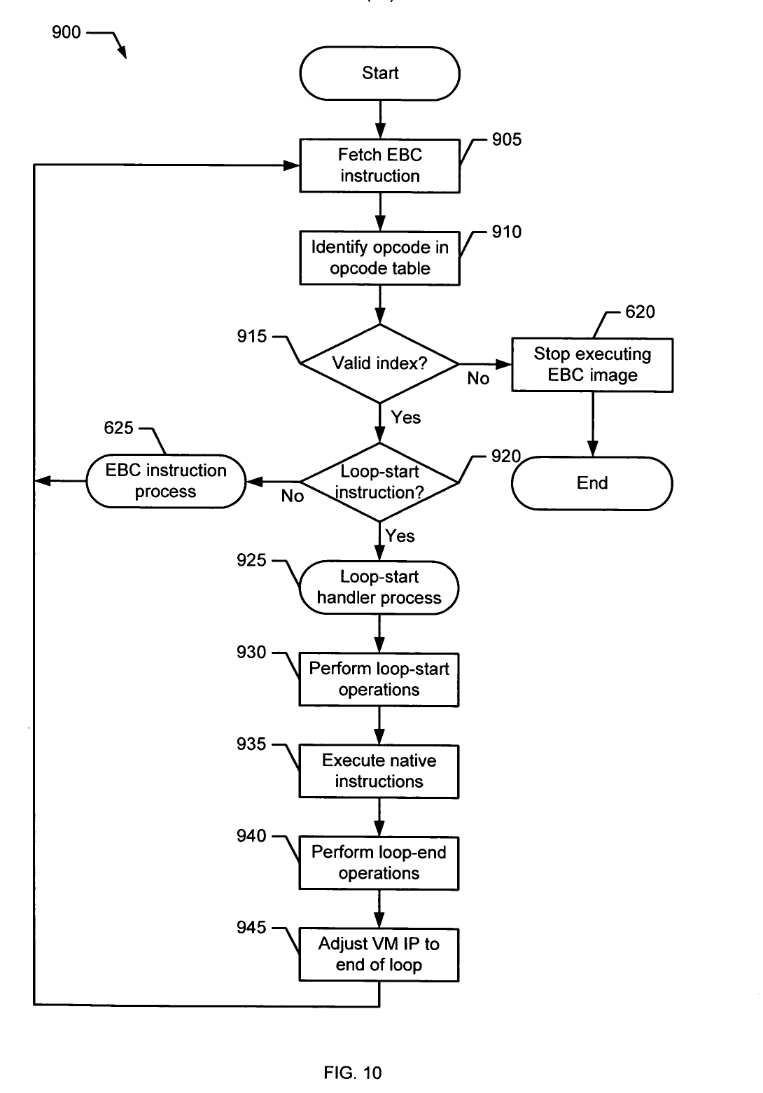

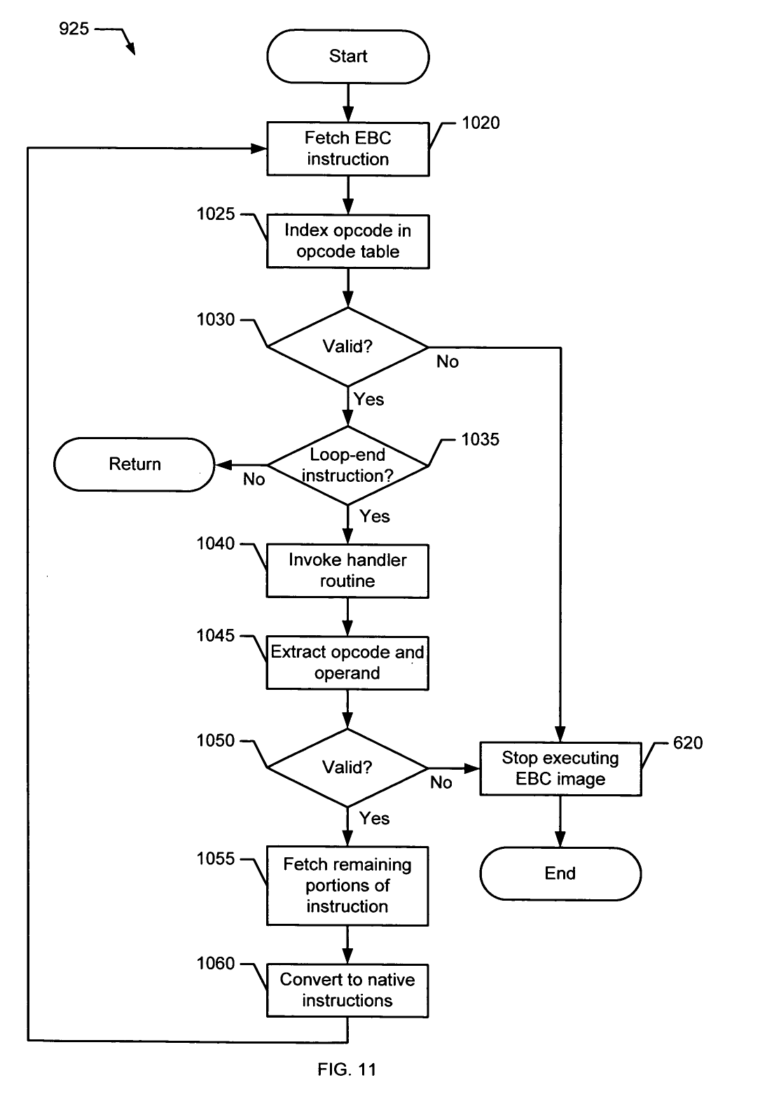

In general, FIG. 6 depicts a flow diagram 600 of a known manner of processing an EBC image. Although the EBCVM 240 is configured to operate in a manner as described in the flow diagrams 900 and 925 shown in FIGS. 10 and 11, respectively, the EBCVM 240 may be used as an example EFI-based VM to describe the functions associated with existing systems as illustrated in the flow diagram 600. In this manner, the flow diagram 600 begins with the EBCVM 240 fetching an EBC instruction (e.g., the EBC instruction 500 of FIG. 5) associated with the EBC image 230 (block 605). Based on a VM IP stored in the VM IP register of the VM context, the EBCVM 240 may retrieve the EBC instruction. That is, the VM IP register may indicate the address of the EBC instruction retrieved at block 605. As noted above, the EBC instruction may include an opcode, operands, and/or immediate data. Based on an opcode table, the EBCVM 240 identifies an operation to be performed as specified by the opcode (block 610). Referring to FIG. 8, an opcode table 700 includes a plurality of opcodes with each opcode corresponding to an operation to be performed. Accordingly, the EBCVM 240 may use the opcode table 700 to identify the operation to be performed as specified by the opcode. For example, the opcode “0x01” may correspond to an operation for executing a jump function (i.e., “ExecuteJMP”) as indicated by an enlarged-bold arrow. In another example, the opcode “0x04” may correspond to an operation for executing a return function (i.e., “ExecuteRET”).

Accordingly, the EBCVM 240 determines whether the operation to be performed as specified by the opcode is valid (block 615). The EBCVM 240 determines that an operation to be performed is invalid if the EBCVM 240 cannot identify the opcode associated with that particular operation on the opcode table 700. If the operation to be performed is invalid, the EBCVM 240 terminates processing of the EBC image 230 because the EBC image 230 includes an invalid operation (i.e., the process 600 ends) (block 620). Otherwise, if the operation to be performed is valid, the EBCVM 240 performs the EBC instruction process 625 as described in connection with FIG. 7.

In the example of FIG. 7, the EBC instruction process 625 begins with initiating a handler routine associated with the opcode identified in block 610 of FIG. 6. By executing handler routine associated the opcode, the EBCVM 240 extracts the opcode and the operands from the EBC instruction (block 635) and determines whether the opcode and the operands are valid (block 640). That is, the EBCVM 240 determines whether the operation specified by the opcode may be performed on the operands. Turning to FIG. 9 as an example, the EBCVM 240 executes a handler routine 800 associated with an opcode that specifies the operation of executing a jump function (i.e., “ExecuteJMP”). In particular, the EBCVM 240 extracts the opcode and the operands by executing the “GETOPERAND” and “GETOPCODE” instructions 810. To determine whether the opcode and the operands are valid, the EBCVM 240 executes the instructions 820.

Referring back to FIG. 7, if the opcode and the operands are invalid, the EBCVM 240 proceeds to block 620 to terminate processing of the EBC image 230 because the EBC image 230 includes an invalid operation (i.e., the process 600 ends). On the other hand, if the opcode and the operands are valid, the EBCVM 240 fetches any remaining portions associated with the EBC instruction such as index or immediate data (block 645). Accordingly, the EBCVM 240 (e.g., via the handler routine) executes the EBC instruction retrieved at block 605 by performing the operation specified by the opcode on the operands and/or the index or immediate data (block 650). Upon executing the EBC instruction retrieved at block 605, the EBCVM 240 adjusts the VM IP register associated with the stack memory 250 by incrementing the VM IP register to point to the VM IP associated with the next EBC instruction for processing (block 655). The EBC instruction process 625 terminates and the EBCVM 240 returns to block 610.

In existing systems, the EBCVM 240 executes the operations depicted in FIGS. 6 and 7 in a manner as described above when the EBC instruction is executed again. For example, the retrieved EBC instruction may be associated with a loop, which causes that particular EBC instruction to be repeatedly processed by the EBCVM 240. Accordingly, the EBCVM 240 repeatedly validates the opcode and operands associated with the retrieved EBC instruction even if the opcode and operands do not change during subsequent execution of that EBC instruction. Thus, as described above and shown in FIGS. 6 and 7, EBC instructions of the EBC image 230 are processed inefficiently in existing systems because of the repeated validations performed on opcodes and operands associated with the EBC instructions.

In contrast to existing systems, the EBC instruction processing system 200 may be configured to eliminate unnecessary validations of opcodes and operands associated with EBC instructions (e.g., repeated validations). By avoiding the unnecessary validations of opcodes and operands, the EBC instruction processing system 200 may reduce the number of clock cycles needed to execute the EBC instructions. Referring back to FIG. 2, the EBC compiler 220 identifies loops in the application 210 and generates a loop-start instruction (e.g., LOOPstart of FIG. 4) and a loop-end instruction (e.g., LOOPend of FIG. 4) in the EBC image 230 for each identified loop including nested loops. In particular, the loop-start instruction may invoke operations associated with a loop-start handler process (e.g., the process 925 of FIGS. 10 and 11) to avoid the unnecessary validations of opcodes and operands. In general, the monitoring unit 242 of the EBCVM 240 monitors for the loop-start instructions and the loop-end instructions associated with the identified loops during processing of the EBC image 230 to avoid validating opcodes and operands associated with EBC instructions for each iteration of the identified loops. In response to detecting the loop-start instruction, the validation unit 244 of the EBCVM 240 validates opcodes and operands associated with EBC instructions in the identified loops. The converting unit 246 of the EBCVM 240 generates native instructions corresponding to the EBC instructions for the underlying processor 270 to execute iterations of the identified loops. Upon detecting the loop-end instructions, the underlying processor 270 executes the native instructions 260 to execute the EBC instructions.

FIG. 10 is a flow diagram depicting one manner in which the example EBC instruction processing system of FIG. 2 may be configured to process an EBC instruction in a loop, and FIG. 11 is a flow diagram depicting one manner in which the example EBC instruction processing system of FIG. 2 may be configured to implement an example loop-start handler process. Persons of ordinary skill in the art will appreciate that the example methods of FIGS. 10 and 11 may be implemented as machine accessible instructions utilizing any of many different programming codes stored on any combination of machine-accessible media such as a volatile or nonvolatile memory or other mass storage device (e.g., a floppy disk, a CD, and a DVD). For example, machine accessible instructions may be embodied in a machine-accessible medium such as an erasable programmable read only memory (EPROM), a read only memory (ROM), a random access memory (RAM), a magnetic media, an optical media, and/or any other suitable type of medium. Alternatively, the machine accessible instructions may be embodied in a programmable gate array and/or an application specific integrated circuit (ASIC). Further, although a particular order of actions is illustrated in FIGS. 10 and 11, persons of ordinary skill in the art will appreciate that these actions can be performed in other temporal sequences. Again, the flow diagrams 900 and 925 are merely provided and described in connection with FIGS. 2-9 as an example of one way to process an EBC instruction in a loop in accordance with the teachings described herein.

Persons of ordinary skill in the art will appreciate that the blocks 905-915 of the flow diagram 900 are similar to the blocks 605-615 of the flow diagram 600. In particular, the flow diagram 900 begins with the EBCVM 240 fetching an EBC instruction (e.g., the EBC instruction 500 of FIG. 5) associated with the EBC image 230 (block 905). Based on a VM IP in the VM IP register of the VM context, the EBCVM 240 may retrieve the EBC instruction. The VM IP register may indicate the address of the EBC instruction. As noted above, the retrieved EBC instruction may include an opcode, operands, and/or immediate data. Based on an opcode table, the EBCVM 240 identifies an operation to be performed as specified by the opcode (block 910). For example, the EBCVM 240 may use the opcode table 700 of FIG. 8 to identify the operation to be performed as specified by the opcode. In this manner, the opcode “0x01” may correspond to an operation for executing a jump function (i.e., “ExecuteJMP”). As another example, the opcode “0x04” may correspond to an operation for executing a return function (i.e., “ExecuteRET”). Accordingly, the EBCVM 240 determines whether the operation to be performed as specified by the opcode is valid (block 915). The EBCVM 240 determines that an operation to be performed is invalid if the EBCVM 240 cannot identify the opcode associated with that particular operation on the opcode table 700. If the operation to be performed is invalid, the EBCVM 240 terminates processing of the EBC image 230 (i.e., the process 900 ends) (block 620). In contrast to existing systems as depicted by the flow diagram 600, the flow diagram 900 proceeds to determine whether the EBC instruction retrieved at block 905 is a loop-start instruction associated with the loop (e.g., LOOPstart of FIG. 4 as indicated by the enlarged bold arrow) if the operation to be performed is valid (block 920). As previously noted, the EBC compiler 220 generated the loop-start instruction along with the loop-end instruction during compilation of the application 210. If the retrieved EBC instruction is not a loop-start instruction, the EBCVM 240 proceeds to the EBC instruction process 625. The EBC instruction process 625 is described above in connection with in FIG. 6 to process the retrieved EBC instruction in a known manner. After executing the EBC instruction process 625, the EBCVM 240 returns to block 905 to fetch another EBC instruction.

On the other hand, if the retrieved EBC instruction is a loop-start instruction, the EBCVM 240 initiates a loop-start handler process 925 associated with the loop-start instruction. In general, the loop-start handler process 925 may be implemented by the monitoring unit 242, the validation unit 244, and the converting unit 246 of the EBCVM 240 to process EBC instructions in a loop (e.g., the loop 450 of FIG. 4). The loop process 925 is configured to avoid unnecessary validations of opcodes and operands during iterations of the loop. As illustrated in FIG. 11, the loop-start handler process 925 begins with the EBCVM 240 fetching an EBC instruction associated with the loop (block 1020). Referring to FIG. 4, for example, the EBCVM 240 may fetch the instruction 410 in the loop 450. In a similar manner as described above, the EBCVM 240 may retrieve the EBC instruction based on a VM IP in the VM IP register of the VM context stored in the stack memory 250. Based on the opcode table 700, the EBCVM 240 identifies an operation to be performed as specified by the opcode associated with the EBC instruction retrieved at block 1020 (block 1025). The EBCVM 240 decodes the EBC instruction by determining whether the operation to be performed is valid (block 1030). The EBCVM 240 determines that an operation to be performed is invalid if the EBCVM 240 cannot identify the opcode associated with that particular operation in the opcode table 700. If the operation to be performed is invalid, the EBCVM 240 terminates processing of the EBC image 230 because the EBC image 230 includes an invalid operation (i.e., the process 900 ends) (block 620). Otherwise, if the operation to be performed is valid, the EBCVM 240 determines whether the EBC instruction retrieved at block 1020 is a loop-end instruction associated with the loop (e.g., LOOPend of FIG. 4 as indicated by the enlarged bold arrow) if the operation to be performed is valid (block 1035). If EBCVM 240 determines that the EBC instruction retrieved at block 1020 is not a loop-end instruction, the EBCVM 240 invokes a handler routine associated with the opcode of the EBC instruction retrieved at block 1020 (block 1040). By executing the handler routine, the EBCVM 240 extracts the opcode and the operands from the EBC instruction retrieved at block 1020 (block 1045) and determines whether the opcode and the operands are valid (block 1050). As described in connection with FIG. 9, for example, the EBCVM 240 may execute a handler routine 800 associated with an opcode that specifies the operation of executing a jump (i.e., “ExecuteJMP”). The EBCVM 240 extracts the opcode and the operands by executing the “GETOPERAND” and “GETOPCODE” instructions 810. Further, the EBCVM 240 executes the instructions 820 to determine whether the opcode and the operands are valid.

Referring back to FIG. 11, if the opcode and the operands of the EBC instruction retrieved at block 1020 are invalid, the EBCVM 240 proceeds to block 620 to terminate execution of the EBC image 230 because the EBC image 230 includes invalid operations and/or registers (i.e., the process 900 ends). On the other hand, if the opcode and the operands are valid, the EBCVM 240 fetches any remaining portions associated with the EBC instruction retrieved at block 1020 such as index or immediate data (block 1055). In contrast to existing systems where handler routines execute the EBC instructions, the EBC instruction processing system 200 converts the EBC instruction to native instructions 260 for the underlying processor 270 to execute (block 1060). The processor architecture of the underlying processor 270 may or may not support the EBC instructions of the EBC image. For example, an IA-32 Intel® Architecture processor does not support 64-bit operands. Accordingly, one-to-one mapping between the EBC instructions and the IA-32 assembly instructions may not be possible. Thus, the operands of the EBC instruction are operated in memory locations of the operands themselves. In one example, the IA-32 assembly instructions may operate on memory location of VM register RI in the VM context if the EBC instruction involves the VM register RI. The EBC instruction may correspond to one or more native instructions (i.e., no one-to-one mapping between instructions). On the other hand, for example, an IA-64 Intel® Architecture processor may include the resources to match the set of VM registers. Accordingly, the VM context of the EBC image may be applied to an IA-64 processor and each EBC instruction may correspond to a single native instruction (i.e., one-to-one mapping). By converting the EBC instruction to native instructions 260, the loop-start handler process 925 save the process context and set the entry point (e.g., DS:ESI) to the address of the VM context of the EBC image as part of the loop-start handler process 925 itself.

Referring to FIGS. 4 and 12, for example, the EBCVM 240 may convert the EBC instructions associated with the loop 450 to native instructions 1100. In particular, the EBCVM 240 may convert the EBC instruction 410 (i.e., “MOVqw R7, R0(+0, +4)”) to native instruction. As another example, the EBCVM 240 may convert the EBC instruction 420 (i.e., “ADD R7, R4”) to native instructions 1120. Upon converting the EBC instruction to native instructions 260, the EBCVM 240 returns to block 1020 to fetch another EBC instruction associated with the loop to validate in a similar manner as described in connection with blocks 1025-1060.

As illustrated in FIG. 11, if the EBCVM 240 detects the loop-end instruction at block 1035, the loop-start handler process 925 terminates and the EBCVM 240 returns to block 930 of the process 900. Referring back to FIG. 10, the EBCVM 240 performs loop-start operations associated with the loop-start handler process 925 initiated at block 925 (block 930). Based on the resources of the underlying processor 270, the EBCVM 240 may perform other tasks needed to execute the generated native instructions 260 associated with the loop. For example, the EBCVM 240 may save the context of the underlying processor 270, and apply the VM context to the underlying processor 270 (i.e., eight general purpose registers, one IP register, one flag register, and a stack). Accordingly, the EBCVM 240 passes control to the underlying processor 270 to execute the native instructions 260 associated with the EBC instruction retrieved at block 1020 (block 935). Instead of each EBC instruction being individually executed by a corresponding handler routine as in existing systems, the underlying processor 270 executes the native instructions 260 corresponding to all the EBC instructions retrieved at block 1020. In existing systems, for example, handler routines corresponding to each of the EBC instructions in the loop 450 of FIG. 4 may execute the EBC instructions. In contrast to existing systems, the underlying processor 270 may execute the native instructions 1100 of FIG. 12, which correspond to the EBC instructions in the loop 450.

After execution of the native instructions 260 corresponding to the EBC instructions retrieved at block 1020, the EBCVM 240 performs loop-end operations (block 940). For example, EBCVM 240 may update the VM context, and restore the context of the underlying processor 270. Following the loop-end operations, the EBCVM 240 adjusts the VM IP by incrementing the VM IP register to point to the next EBC instruction in the EBC image 230 (block 945). The EBCVM 240 returns to block 905 to fetch and process the next EBC instruction as described in above. For example, the VM IP register may point to an EBC instruction immediately after the loop-end instruction.

As described in detail above in connection with FIGS. 10 and 11, the EBC instruction processing system 200 described herein processes an EBC instruction of a loop without invoking a handler routine associated with the EBC instruction repeatedly. Existing systems typically decodes the EBC instruction and executes the decoded EBC instructions. To execute the loop, existing systems generate native instructions corresponding to the EBC instruction repeatedly during iteration of the loop. Instead, the EBC instruction processing system 200 invoke the handler routine once (e.g., at block 1040), validates and decodes the EBC instruction, and converts the EBC instruction to native instructions for the underlying processor 270 to execute the loop iteration.

The methods and apparatus disclosed herein are well suited for a processor system having an EBCVM. However, persons of ordinary skill in the art will appreciate that the teachings of the disclosure may be applied to other processor systems having one or more VMs.

FIG. 13 is a block diagram of an example processor system 2000 adapted to implement the methods and apparatus disclosed herein. The processor system 2000 may be a desktop computer, a laptop computer, a notebook computer, a personal digital assistant (PDA), a server, an Internet appliance or any other type of computing device.

The processor system 2000 illustrated in FIG. 13 includes a chipset 2010, which includes a memory controller 2012 and an input/output (I/O) controller 2014. As is well known, a chipset typically provides memory and I/O management functions, as well as a plurality of general purpose and/or special purpose registers, timers, etc. that are accessible or used by a processor 2020. The processor 2020 is implemented using one or more processors. For example, the processor 2020 may be implemented using one or more of the Intel® Pentium® technology, the Intel® Itanium® technology, Intel® Centrino™ technology, and/or the Intel® XScale® technology. In the alternative, other processing technology may be used to implement the processor 2020. The processor 2020 includes a cache 2022, which may be implemented using a first-level unified cache (L1), a second-level unified cache (L2), a third-level unified cache (L3), and/or any other suitable structures to store data as persons of ordinary skill in the art will readily recognize.

As is conventional, the memory controller 2012 performs functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 also includes an interface circuit 2050 that is coupled to the bus 2040. The interface circuit 2050 may be implemented using any type of well known interface standard such as an Ethernet interface, a universal serial bus (USB), a third generation input/output interface (3GIO) interface, and/or any other suitable type of interface.

One or more input devices 2060 are connected to the interface circuit 2050. The input device(s) 2060 permit a user to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 are also connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050, thus, typically includes, among other things, a graphics driver card.

The processor system 2000 also includes one or more mass storage devices 2080 to store software and data. Examples of such mass storage device(s) 2080 include floppy disks and drives, hard disk drives, compact disks and drives, and digital versatile disks (DVD) and drives.

The interface circuit 2050 also includes a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network is typically controlled by the I/O controller 2014 in a conventional manner. In particular, the I/O controller 2014 performs functions that enable the processor 2020 to communicate with the input device(s) 2060, the output device(s) 2070, the mass storage device(s) 2080 and/or the network via the bus 2040 and the interface circuit 2050.

While the components shown in FIG. 13 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, persons of ordinary skill in the art will readily appreciate that the memory controller 2012 and the I/O controller 2014 may be integrated within a single semiconductor circuit.

Although certain example methods, apparatus, and articles of manufacture haven been described herein, the scope of coverage of this patent is not limited thereto. On the contrary, this patent covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

1. A method comprising:
monitoring for at least one of a loop-start instruction and a loop-end instruction associated with a loop having a virtual machine instruction;
validating the virtual machine instruction in response to detecting the loop-start instruction; and
converting the virtual machine instruction into one or more native instructions in response to a failure to detect the loop-end instruction.

2. A method as defined in claim 1 further comprising executing one or more native instructions associated with the loop.

3. A method as defined in claim 1 further comprising executing an operation associated with the at least one of the loop-start instruction and the loop-end instruction.

4. A method as defined in claim 1 further comprising generating the at least one of the loop-start instruction and the loop-end instruction.

5. A method as defined in claim 1 further comprising terminating processing of a virtual machine image associated with the virtual machine instruction in response to detecting an invalid operating parameter.

6. A method as defined in claim 1, wherein the virtual machine instruction comprises an extensible firmware interface (EFI) byte code (EBC) instruction.

7. A method as defined in claim 1, wherein the virtual machine instruction comprises at least one of an opcode, an operand, and immediate data.

8. A method as defined in claim 1, wherein the loop comprises a nested loop.

9. A machine accessible medium having instructions, which when executed, cause a machine to:
monitor for at least one of a loop-start instruction and a loop-end instruction associated with a loop having a virtual machine instruction;
validate the virtual machine instruction in response to detecting the loop-start instruction; and
convert the virtual machine instruction into one or more native instructions in response to a failure to detect the loop-end instruction.

10. A machine accessible medium as defined in claim 9, wherein the instructions, when executed, cause the machine to execute one or more native instructions associated with the loop.

11. A machine accessible medium as defined in claim 9, wherein the instructions, when executed, cause the machine to execute an operation associated with the at least one of the loop-start instruction and the loop-end instruction.

12. A machine accessible medium as defined in claim 9, wherein the instructions, when executed, cause the machine to generate the at least one of the loop-start instruction and the loop-end instruction.

13. A machine accessible medium as defined in claim 9, wherein the instructions, when executed, cause the machine to terminate processing of a virtual machine image associated with the virtual machine instruction in response to detecting an invalid operating parameter.

14. A machine accessible medium as defined in claim 9, wherein the virtual machine instruction comprises an extensible firmware interface (EFI) byte code (EBC) instruction.

15. A machine accessible medium as defined in claim 9, wherein the virtual machine instruction comprises at least one of an opcode, an operand, and immediate data.

16. An apparatus comprising:
a monitoring unit to monitor for at least one of a loop-start instruction and a loop-end instruction associated with a loop having a virtual machine instruction;
a validation unit to validate the virtual machine instruction in response to detecting the loop-start instruction; and
a converting unit configured to convert the virtual machine instruction into one or more native instructions in response to a failure to detect the loop-end instruction.

17. An apparatus as defined in claim 16 further comprising a processor configured to execute the one or more native instructions associated with the loop.

18. An apparatus as defined in claim 16, wherein the validation unit is configured to execute an operation associated with the at least one of the loop-start instruction and the loop-end instruction.

19. An apparatus as defined in claim 16, wherein the validation unit is configured to terminate processing of a virtual machine image associated with the virtual machine instruction in response to detecting an invalid operating parameter.

20. An apparatus as defined in claim 16, wherein the virtual machine instruction comprises an extensible firmware interface (EFI) byte code (EBC) instruction.

21. An apparatus as defined in claim 16, wherein the virtual machine instruction comprises at least one of an opcode, an operand, and immediate data.

22. A processor system comprising:
a dynamic random memory (DRAM) to store a virtual machine image having a plurality of virtual machine instructions; and
a processor coupled to the DRAM to monitor for at least one of a loop-start instruction and a loop-end instruction associated with a loop having a virtual machine instruction of the plurality of virtual machine instructions, to validate the virtual machine instruction in response to detecting the loop-start instruction, and to convert the virtual machine instruction into one or more native instructions in response to a failure to detect the loop-end instruction.

23. A processor system as defined in claim 22, wherein the processor is configured to execute the one or more native instructions associated with the loop.

24. A processor system as defined in claim 22, wherein the processor is configured to execute an operation associated with the at least one of the loop-start instruction and the loop-end instruction.

25. A processor system as defined in claim 22, wherein the processor configured to terminate processing of the virtual machine image in response to detecting an invalid operating parameter.

26. A processor system as defined in claim 22, wherein the virtual machine instruction comprises an extensible firmware interface (EFI) byte code (EBC) instruction.

27. A processor system as defined in claim 22, wherein virtual machine instruction comprises at least one of an opcode, an operand, and immediate data.
